(19) United States
(12) Patent Application Publication
(10) Pub. No.: US 2007/0038925 A1
(43) Pub. Date: Feb. 15, 2007

(54) Client-server interface to push messages to the client browser

(76) Inventors: Chia-Hsin Li, San Jose, CA (US); Steve Nelson, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/199,600

(22) Filed: Aug. 9, 2005

(51) Int. Cl. G06F 17/24

(52) U.S. Cl. 715/513

(57) ABSTRACT

An electronic document having a corresponding method, apparatus, and computer program for generating the electronic document comprises a plurality of markup language elements parseable by a browser application to display a page; a browser plug-in adapted to open a network connection with a server, to receive unsolicited event messages from the server over the network connection, and to modify contents of a state table based on the event messages; and a browser script executable by the browser application to read the state table, and to modify the displayed page according to the contents of the state table.

### BACKGROUND

The present invention relates generally to data communications. More particularly, the present invention relates to a client-server interface to push messages to the client browser.

### SUMMARY

In general, in one aspect, the invention features a method for generating an electronic document comprising: providing a plurality of markup language elements parseable by a browser application to display a page; providing a browser plug-in adapted to open a network connection with a server, to receive unsolicited event messages from the server over the network connection, and to modify contents of a state table based on the event messages; and providing a browser script executable by the browser application to read the state table, and to modify the displayed page according to the contents of the state table.

In some embodiments, the plurality of markup language elements comprises a tag parseable by the browser application to display a control; and wherein, when the control is selected, the browser plug-in sends a corresponding command message to the server over the network connection. In some embodiments, the markup language elements are selected from at least one of: Hypertext Markup Language (HTML); Dynamic Hypertext Markup Language (DHTML); Extensible Markup Language (XML); or Extensible Hypertext Markup Language (XHTML). In some embodiments, the browser plug-in comprises at least one of: an ActiveX control; a Java applet; or a Mozilla/Netscape plug-in. In some embodiments, the browser script is based on at least one of: JavaScript; or Microsoft Visual Basic Scripting Edition (VBScript). In some embodiments, the network connection is secure. In some embodiments, the event messages represent events in a videoconference; and wherein the command messages represent commands executable by the server to modify the videoconference. Some embodiments comprise an apparatus to perform the method. Some embodiments comprise a computer program to perform the method.

In general, in one aspect, the invention features a method comprising: executing a browser application; receiving an electronic document comprising a plurality of markup language elements, a browser plug-in, and a browser script; displaying a page based on the markup language elements; executing the browser plug-in, wherein the browser plug-in opens a network connection with a server, receives unsolicited event messages from the server over the network connection, and modifies contents of a state table based on the event messages; and executing the browser script to read the state table, and to modify the displayed page according to the contents of the state table.

In some embodiments, the plurality of markup language elements comprises a tag parseable by the browser application to display a control; and wherein, when the control is selected, the browser plug-in sends a corresponding command message to the server over the network connection. In some embodiments, the markup language elements are selected from at least one of: Hypertext Markup Language (HTML); Dynamic Hypertext Markup Language (DHTML); Extensible Markup Language (XML); or Extensible Hypertext Markup Language (XHTML). In some embodiments, the browser plug-in comprises at least one of: an ActiveX control; a Java applet; or a Mozilla/Netscape. In some embodiments, the browser script is based on at least one of: JavaScript; or Microsoft Visual Basic Scripting Edition (VBScript). In some embodiments, the network connection is secure. In some embodiments, the event messages represent events in a videoconference; and wherein the command messages represent commands executable by the server to modify the videoconference. Some embodiments comprise an apparatus to perform the method. Some embodiments comprise a computer program to perform the method. Some embodiments comprise the electronic document generated by the method.

In general, in one aspect, the invention features an electronic document comprising: a plurality of markup language elements parseable by a browser application to display a page; a browser plug-in adapted to open a network connection with a server, to receive unsolicited event messages from the server over the network connection, and to modify contents of a state table based on the event messages; and a browser script executable by the browser application to read the state table, and to modify the displayed page according to the contents of the state table.

The details of one or more implementations are set forth in the accompanying drawings and the description below. Other features will be apparent from the description and drawings, and from the claims.

### DESCRIPTION OF DRAWINGS

FIG. 1 shows a client-server interface provided by the world wide web.

FIG. 2 shows a videoconferencing system according to a preferred embodiment of the present invention.

FIG. 3 shows detail of the owner client of FIG. 2 according to a preferred embodiment of the present invention.

FIG. 4 shows a process for the owner client of FIG. 2 according to a preferred embodiment of the present invention.

The leading digit(s) of each reference numeral used in this specification indicates the number of the drawing in which the reference numeral first appears.

### DETAILED DESCRIPTION

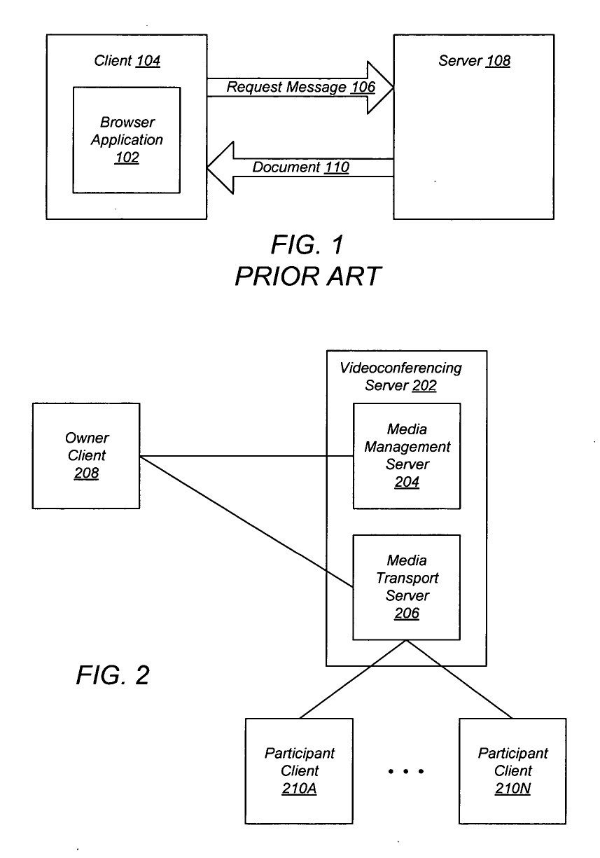

The most popular data communications interface in use today is the client-server interface provided by the World Wide Web, which is summarized in FIG. 1. According to this interface, a browser application 102 executing on a client 104 sends a request message 106 to a server 108, which can respond by sending an electronic document 110 that is subsequently displayed by browser application 102. This request/response interface works well for most purposes. But for client applications that require frequent updates from the server 108, the number of requests can grow to unduly burden the server 108. For example, the owner of a videoconferencing application must know the current status of the videoconference. In order to keep the status current using the conventional request/response technique described above, client 104 would have to send a request message 106 to server 108 at a frequency on the order of once per second or more.

Embodiments of the present invention provide a client-server interface to push messages from the server to the client browser. As used herein, the terms “client” and “server” generally refer to an electronic device or mechanism, and the term “message” generally refers to an electronic signal representing a digital message. As used herein, the term “mechanism” refers to hardware, software, or any combination thereof. These terms are used to simplify the description that follows. The clients, servers, and mechanisms described herein can be implemented on any standard general-purpose computer, or can be implemented as specialized devices.

FIG. 2 shows a videoconferencing system 200 according to a preferred embodiment of the present invention. While embodiments of the present invention are described with reference to monitoring and controlling a videoconferencing system, embodiments of the present invention can be used to transport any sort of data, as will be apparent to one skilled in the relevant arts after reading this description.

Videoconferencing system 200 comprises a videoconferencing server 202 comprising a media management server 204 and a media transport server 206, an owner client 208 for an owner of a videoconference, and a plurality of participant clients 210A-N for participants in the videoconference. Each participant client 210 has a connection to media transport server 206 for the exchange of the audio and video data of the videoconference, thereby allowing participants to hear and see each other. Owner client 208 has a management connection to media management server 204 that allows an owner of the videoconference to monitor and manage the videoconference, as described in detail below. Owner client 208 can also have a connection to media transport server 206 to enable the owner to participate in the videoconference.

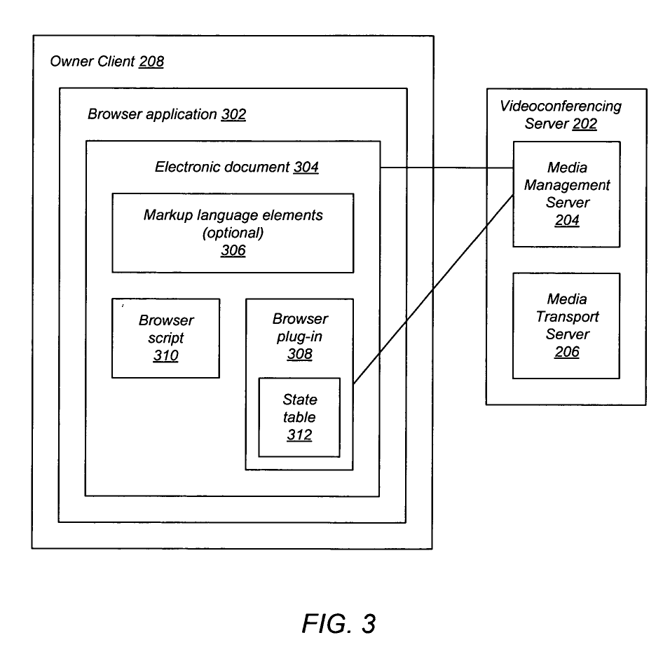

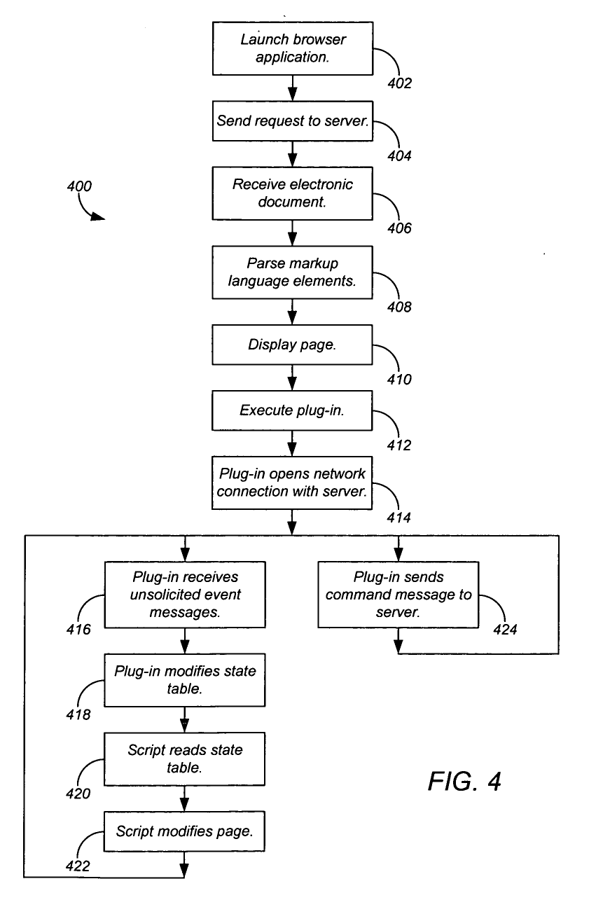

FIG. 3 shows detail of owner client 208 of FIG. 2 according to a preferred embodiment of the present invention. FIG. 4 shows a process 400 for owner client 208 of FIG. 2 according to a preferred embodiment of the present invention. To initiate a videoconference, owner client 208 launches a browser application 302 (step 402), and points browser application 302 to media management server 204. In response, browser application 302 sends a request message such as an HTTP request message to media management server 204 (step 404). In response, media management server 204 sends an electronic document 304 to owner client 208, where it is received by browser application 302 (step 406).

Electronic document 304 comprises a plurality of optional markup language elements 306, a browser plug-in 308, and a browser script 310. Markup language elements 306 can be written in Hypertext Markup Language (HTML), Dynamic Hypertext Markup Language (DHTML), Extensible Markup Language (XML), Extensible Hypertext Markup Language (XHTML), or the like. Browser plug-in 308 can be implemented as an ActiveX control, a Java applet, a Mozilla/Netscape plug-in, or the like. Preferably browser plug-in 308 is packaged in a signed cabinet (.cab) file or the like for added security. Browser script 310 can be written in JavaScript, Microsoft Visual Basic Scripting Edition (VBScript), or the like.

Browser application 302 parses markup language elements 306 (step 408) and displays a page based on markup language elements 306 (step 410). For example, browser application 302 parses HTML elements to create a Document Object Model (DOM), and then renders the DOM as a page for the user to view. In some embodiments, the DOM is created or enhanced directly by browser script 310, rendering optional markup language elements 306 unnecessary.

Browser application 302 also executes browser plug-in 308 (step 412). Browser plug-in 308 opens a network connection with media management server 204 (step 414). Preferably the network connection is a secure connection such as a secure sockets layer (SSL) connection.

Browser plug-in 308 subsequently receives unsolicited event messages from media management server 204 over the network connection (step 416). The event messages are unsolicited in the sense that owner client 208 does not poll media management server 204 to send the event messages. Instead, media management sever 204 pushes the event messages to owner client 208 as the event messages become available. This push technique relieves owner client 208 of the obligation to constantly poll media management server 204, and therefore relieves media management server 204 of the obligation to process, and to respond to, the numerous polling messages owner client 208 would otherwise send.

Preferably the event messages represent events in the videoconference. For example, an event can relate that a participant has connected to the videoconference. Browser plug-in 308 preferably maintains a state table 312 describing the status of the videoconference. For example, the status can describe the connection status of each participant (for example, disconnected, connecting, or connected), the status of each audio-video connection (for example, video frame rate and audio bandwidth), the CPU load of videoconferencing server 202, the status of media files uploaded and downloaded by the participants, and the like. Upon receiving an event message, browser plug-in 308 modifies the contents of state table 312 based on the event message (step 418).

Browser script 310 reads state table 312 (step 420). In some embodiments, browser script 310 polls browser plug-in 308 to learn of changes in state table 312, for example by comparing state table 312 with a previously-read version, by testing a flag set by browser plug-in 308 on modifying state table 312, and the like. In other embodiments, browser plug-in 308 pushes all or part of state table 312 to browser script 310 regularly, after modifying state table 312, and the like. Browser script 310 modifies the displayed page according to the contents of state table 312 (step 422).

The network connection between browser plug-in 308 and media management server 204 can also be used to control the videoconference by passing command messages to media management server 204. Preferably markup language elements 306 comprise tags parseable by browser application 302 to display a control such as a button, listbox, checkbox, edit box, and the like. When the image is selected, for example by clicking on the image using a mouse, browser plug-in 308 sends a corresponding command message to media management server 204 over the network connection (step 424). For example, in response to selection of the image, browser script 310 calls a corresponding method in browser plug-in 308, which then sends a corresponding command message to media management server 204 over the network connection. For the current videoconferencing example, the command message can comprise commands to disconnect a participant, invite a participant, mute the audio or blind the video for a participant, change the video layout of a participant, transfer control of the meeting from one participant to another, and the like. In response, media management server 204 modifies the videoconference accordingly.

Embodiments of the present invention can be implemented in digital electronic circuitry, or in computer hardware, firmware, software, or in combinations of them. An apparatus of the invention can be implemented using a program or set of instructions (e.g., computer program) tangibly embodied in a machine-readable storage medium for execution by a programmable processor; and method steps of the invention can be performed by a programmable processor executing a program of instructions to perform various functions of the invention by operating on input data and generating output. Aspects of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices or mediums suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Computer program instructions can also be embodied in a suitable electromagnetic carrier wave (waveform) that is conveyed to a programmable processor. Program instructions for implementing aspects of the invention can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. A method for generating an electronic document comprising:
providing a plurality of markup language elements parseable by a browser application to display a page;
providing a browser plug-in adapted to open a network connection with a server, to receive unsolicited event messages from the server over the network connection, and to modify contents of a state table based on the event messages; and
providing a browser script executable by the browser application to read the state table, and to modify the displayed page according to the contents of the state table.

2. The method of claim 1:
wherein the plurality of markup language elements comprises a tag parseable by the browser application to display a control; and
wherein, when the control is selected, the browser plug-in sends a corresponding command message to the server over the network connection.

3. The method of claim 1, wherein the markup language elements are selected from at least one of:
Hypertext Markup Language (HTML);
Dynamic Hypertext Markup Language (DHTML);
Extensible Markup Language (XML); or
Extensible Hypertext Markup Language (XHTML).

4. The method of claim 1, wherein the browser plug-in comprises at least one of:
an ActiveX control;
a Java applet; or
a Mozilla/Netscape plug-in.

5. The method of claim 1, wherein the browser script is based on at least one of:
JavaScript; or
Microsoft Visual Basic Scripting Edition (VBScript).

6. The method of claim 1, wherein the network connection is secure.

7. The method of claim 1:
wherein the event messages represent events in a videoconference; and
wherein the command messages represent commands executable by the server to modify the videoconference.

8. An apparatus configured to perform the method of claim 1.

9. A medium or waveform containing a set of instructions for directing an instruction-executing device to perform the method of claim 1.

10. A method comprising:
executing a browser application;
receiving an electronic document comprising
a plurality of markup language elements,
a browser plug-in, and
a browser script;
displaying a page based on the markup language elements;
executing the browser plug-in, wherein the browser plug-in opens a network connection with a server, receives unsolicited event messages from the server over the network connection, and modifies contents of a state table based on the event messages; and
executing the browser script to read the state table, and to modify the displayed page according to the contents of the state table.

11. The method of claim 10:
wherein the plurality of markup language elements comprises a tag parseable by the browser application to display a control; and
wherein, when the control is selected, the browser plug-in sends a corresponding command message to the server over the network connection.

12. The method of claim 10, wherein the markup language elements are selected from at least one of:
Hypertext Markup Language (HTML);
Dynamic Hypertext Markup Language (DHTML);
Extensible Markup Language (XML); or
Extensible Hypertext Markup Language (XHTML).

13. The method of claim 10, wherein the browser plug-in comprises at least one of:
an ActiveX control;
a Java applet; or
a Mozilla/Netscape.

14. The method of claim 10, wherein the browser script is based on at least one of:
JavaScript; or
Microsoft Visual Basic Scripting Edition (VBScript).

15. The method of claim 10, wherein the network connection is secure.

16. The method of claim 10:
wherein the event messages represent events in a videoconference; and
wherein the command messages represent commands executable by the server to modify the videoconference.

17. An apparatus configured to perform the method of claim 10.

18. A medium or waveform containing a set of instructions for directing an instruction-executing device to perform the method of claim 10.

19. An electronic document generated by the method of claim 10.

20. An electronic document comprising:
a plurality of markup language elements parseable by a browser application to display a page;
a browser plug-in adapted to open a network connection with a server, to receive unsolicited event messages from the server over the network connection, and to modify contents of a state table based on the event messages; and
a browser script executable by the browser application to read the state table, and to modify the displayed page according to the contents of the state table.
